(19) United States
(12) Patent Application Publication
(10) Pub. No.: US 2024/0227610 A1
(43) Pub. Date: Jul. 11, 2024

(54) METHOD AND APPARATUS OF OVER-TEMPERATURE PROTECTION FOR CHARGING APPARATUS AND ELECTRIC VEHICLE

(71) Applicant: BYD COMPANY LIMITED, SHENZHEN (CN)

(72) Inventors: Heping LING, Shenzhen (CN); Zhen ZHAI, Shenzhen (CN); Junhua LIU, Shenzhen (CN); Wei LIANG, Shenzhen (CN); Yulin SUN, Shenzhen (CN)

(21) Appl. No.: 18/612,004

(22) Filed: Mar. 21, 2024

Related U.S. Application Data
(63) Continuation of application No. PCT/CN2022/141823, filed on Dec. 26, 2022.

(30) Foreign Application Priority Data
Dec. 30, 2021 (CN) 202111649681.0

(51) Int. Cl. B60L 53/62; B60L 53/68

(52) U.S. Cl. CPC B60L 53/62; B60L 53/68

(57) ABSTRACT

A method of over-heating protection for a charging apparatus, includes: measuring a charging parameter of the charging apparatus during a charging process, where the charging parameter includes a temperature and a time corresponding to the temperature; estimating a temperature change trend of the charging apparatus based on the charging parameter; and when determining, based on the temperature change trend, that a highest estimated temperature exceeds an upper limit of a preset temperature range, limiting a charging current for the charging apparatus before an estimated temperature exceeds the upper limit of the preset temperature range.

### CROSS-REFERENCE TO RELATED APPLICATIONS

The application is a continuation application of International Patent Application No. PCT/CN2022/141823 filed on Dec. 26, 2022, which is based on and claims priority to and benefits of Chinese Patent Application No. 202111649681.0 filed on Dec. 30, 2021. The entire content of all of the above-referenced applications is incorporated herein by reference.

### FIELD

The present disclosure relates to the technical field of charging over-heating protection, and more particularly, to a method of over-heating protection for a charging apparatus, an apparatus of over-heating protection for a charging apparatus, an electric vehicle and a non-transitory computer-readable storage medium.

### BACKGROUND

With the development of electric vehicles, the charging power of electric vehicles gradually increases, and the risk of over-heating ablation of sockets of charged vehicles increases. Currently, a common over-heating protection measure for sockets of charging vehicles is to arrange/configure temperature sensors on internal terminals of the sockets of the charging vehicles and set temperature upper limits (temperature thresholds) that the terminals allow. When the temperatures of the terminals reach the upper temperature limits, the entire vehicles reduce charging currents, thereby lowering the temperatures of the sockets of the charging vehicles.

In the above solution, if the temperature threshold is set to be excessively high, the temperatures of the terminals may exceed the temperature resistance limits of the materials of the charging apparatuses. The high temperature causes the mechanical and electrical properties of the materials to degrade. Since the degradation is irreversible, this causes permanent damage to the vehicle apparatuses. If the temperature threshold of the charging port is set to be excessively low, it is vulnerable to have frequent current restriction, which will prolong the charging time and deteriorate the user experience.

### SUMMARY

The present disclosure proposes a method of over-heating protection for a charging apparatus.

The present disclosure proposes an apparatus of over-heating protection for a charging apparatus.

The present disclosure proposes an electric vehicle.

The present disclosure proposes a non-transitory computer-readable storage medium.

An embodiment of a first aspect of the present disclosure proposes a method of over-heating protection for a charging apparatus, including: measuring a charging parameter of the charging apparatus during a charging process, wherein the charging parameter comprises a temperature and a time corresponding to the temperature; estimating a temperature change trend of the charging apparatus based on the charging parameter; and when determining, based on the temperature change trend, that a highest estimated temperature exceeds an upper limit of a preset temperature range, limiting a charging current for the charging apparatus before an estimated temperature exceeds the upper limit of the preset temperature range.

According to the embodiments of the present disclosure, in the method of over-heating protection for a charging apparatus, first, a charging parameter of a charging apparatus during a charging process is obtained, a temperature change trend of the charging apparatus is estimated based on the charging parameter, and finally, when it is determined based on the temperature change trend that the highest estimated temperature is about to exceed a preset temperature threshold (e.g., the upper limit of the preset temperature range), the charging current is limited before the highest estimated temperature exceeds the preset temperature threshold.

Additionally, the method of over-heating protection for a charging apparatus according to the embodiments of the present disclosure may further have the following additional technical features.

According to an embodiment of the present disclosure, the estimating a temperature change trend of the charging apparatus based on the charging parameter includes: determining a fitting function and a plurality of charging parameters of a plurality of sampling points; substituting the charging parameters of the sampling points into the fitting function to obtain various parameters in the fitting function; substituting the various parameters into the fitting function to obtain a temperature estimation model of the charging apparatus; and estimating the temperature change trend of the charging apparatus based on the charging parameters and the temperature estimation model.

According to an embodiment of the present disclosure, the fitting function is expressed by:

$$T = {C}_{0} + {C}_{1} t + {C}_{2} {t}^{2} + {C}_{3} {t}^{3} + … + {C}_{n - 1} {t}^{n - 1}$$

where T represents a temperature of the charging apparatus, t represents a charging time, C₀ to Cₙ₋₁ represent the various parameters of the fitting function, and n is a number of the temperature sampling points.

According to another embodiment of the present disclosure, the fitting function is expressed by:

$$T ( t ) = {A}_{0} + {\sum }_{j = 1}^{n} {B}_{j} {e}^{- n {t}_{i}} + {\sum }_{j = 1}^{n} {C}_{j} arctan {t}_{i}$$

where T represents a temperature of the charging apparatus, t represents a charging time, A₀, B₁ to Bₙ, and C₁ to Cₙ represent the various parameters of the fitting function, and n is a number of the temperature sampling points.

According to an embodiment of the present disclosure, the limiting the charging current for the charging apparatus before the estimated temperature exceeds the upper limit of the preset temperature range includes: limiting the charging current by gradually adjusting the charging current such that the highest estimated temperature is reduced to within a preset temperature range.

According to an embodiment of the present disclosure, the limiting the charging current by gradually adjusting the charging current includes: determining an initial current during the charging process; reducing the initial current by an amount to obtain a first current; and controlling the charging apparatus to charge a device with the first current, obtaining a first charging parameter within a first time period, estimating the temperature change trend of the charging apparatus based on the first charging parameter within the first time period, and updating the highest estimated temperature, if the updated highest estimated temperature exceeds an upper limit of the preset temperature range, reducing the first current by the amount, until the updated highest estimated temperature does not exceed the upper limit of the preset temperature range.

According to an embodiment of the present disclosure, the limiting the charging current by gradually adjusting the charging current further includes: controlling the charging apparatus to charge the device with the first current; if the updated highest estimated temperature does not exceed the upper limit of the preset temperature range, determining a relationship between the updated highest estimated temperature and a lower limit of the preset temperature range; and if the updated highest estimated temperature is less than the lower limit of the preset temperature range, determining a second current based on the initial current and the first current, controlling the charging apparatus to charge the device with the second current, obtaining a second charging parameter within a second time period, estimating the temperature change trend of the charging apparatus based on the second charging parameter within the second time period, updating the updated highest estimated temperature to obtain a second updated highest estimated temperature, if the second updated highest estimated temperature is less than the lower limit of the preset temperature range, assigning a value of the second current to the first current, until the second updated highest estimated temperature is greater than or equal to the lower limit of the preset temperature range, wherein the second current is greater than the first current and less than the initial current.

According to an embodiment of the present disclosure, the limiting the charging current by gradually adjusting the charging current further includes: if the second updated highest estimated temperature is greater than the upper limit of the preset temperature range, assigning the value of the second current to the initial current until a second subsequent updated highest estimated temperature is less than or equal to the upper limit of the preset temperature range.

According to an embodiment of the present disclosure, the determining a second current according to the initial current and the first current includes: adding the initial current and the first current to obtain a sum, and halving the sum to obtain the second current.

According to an embodiment of the present disclosure, the limiting the charging current by gradually adjusting the charging current further includes: if the second updated highest estimated temperature is within the preset temperature range, maintaining the second current.

According to an embodiment of the present disclosure, the limiting the charging current by gradually adjusting the charging current further includes: if the updated highest estimated temperature is within the preset temperature range, maintaining the first current.

An embodiment of a second aspect of the present disclosure proposes an apparatus of over-heating protection for a charging apparatus, including: an obtaining module, configured to measure a charging parameter of a charging apparatus during a charging process, where the charging parameter includes a temperature and a time corresponding to the temperature; an estimation module, configured to estimate a temperature change trend of the charging apparatus based on the charging parameter; and a protection control module, configured to: when determining, based on the temperature change trend, that the highest estimated temperature exceeds an upper limit of the preset temperature range, limiting a charging current for the charging apparatus before an estimated temperature exceeds the upper limit of the preset temperature range.

According to the apparatus of over-heating protection for a charging apparatus according to the embodiments of the present disclosure, the obtaining module obtains or measures a charging parameter of a charging apparatus during a charging process, the estimation module estimates a temperature change trend of the charging apparatus based on the charging parameter, and when it is determined, based on the temperature change trend, that the highest estimated temperature is about to exceed a preset temperature threshold (e.g., the upper limit of the preset temperature range), the protection control module limits the charging current before the highest estimated temperature exceeds the preset temperature threshold.

An embodiment of a third aspect of the present disclosure provides an electric vehicle, including: a memory, a processor, and an over-heating protection program for a charging apparatus stored in the memory and executable on the processor, when the over-heating protection program is executed by the processor, the foregoing method of over-heating protection for a charging apparatus is implemented.

An embodiment of a fourth aspect of the present disclosure provides a non-transitory computer-readable storage medium, storing an over-heating protection program for a charging apparatus, when the over-heating protection program for a charging apparatus is executed by a processor, the foregoing method of over-heating protection for a charging apparatus being implemented.

The additional aspects and advantages of the present disclosure will be provided in the following description, some of which will become apparent from the following description or may be learned from practices of the present disclosure.

### BRIEF DESCRIPTION OF THE DRAWINGS

FIG. 1 is a flowchart of a method of over-heating protection for a charging apparatus according to an embodiment of the present disclosure;

FIG. 2 is a schematic structural diagram of a terminal of a charging apparatus and another terminal of the charging apparatus paired with the terminal according to an embodiment of the present disclosure;

FIG. 3 is a flowchart of a method of over-heating protection for a charging apparatus according to an embodiment of the present disclosure;

FIG. 4 is a flowchart of gradually controlling a charging current according to an embodiment of the present disclosure;

FIG. 5 is a schematic block diagram of an apparatus of over-heating protection for a charging apparatus according to an embodiment of the present disclosure; and

FIG. 6 is a schematic block diagram of an electric vehicle according to an embodiment of the present disclosure.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are examples, and are to explain the present disclosure and cannot be construed as a limitation on the present disclosure.

The method of over-heating protection for a charging apparatus, the apparatus of over-heating protection for a charging apparatus, the electric vehicle and the non-transitory computer-readable storage medium proposed/provided by the embodiments of the present disclosure are described below with reference to the accompanying drawings.

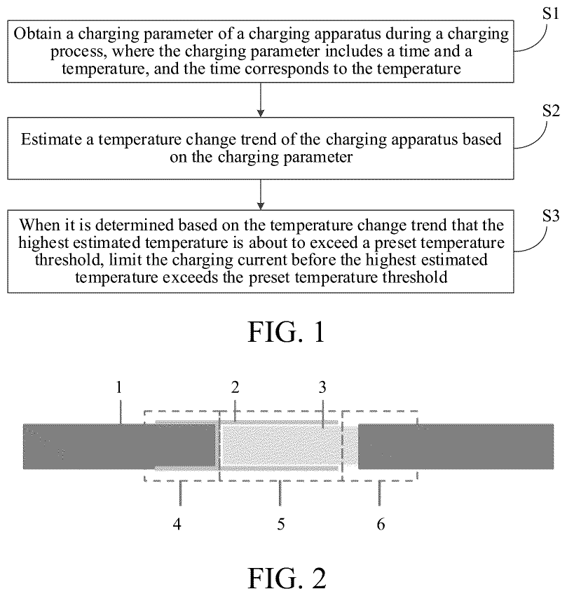

FIG. 1 is a flowchart of a method of over-heating protection for a charging apparatus according to an embodiment of the present disclosure. The charging apparatus can be applied to devices such as electric vehicles and electric scooters that require charging operations.

As shown in FIG. 1, the method of over-heating protection for a charging apparatus according to the embodiments of the present disclosure may include:

S1: A charging parameter of a charging apparatus during a charging process is obtained by measuring, where the charging parameter includes a time and a temperature, and the time corresponds to the temperature.

In an embodiment, a real-time temperature of the terminal can be collected by a temperature sensor installed at the terminal of the charging apparatus, and used as a temperature in the charging parameter of the charging apparatus. That is, after charging starts, the temperature of the terminal corresponding to a time point is collected and is recorded as a charging parameter. For example, a collection cycle can be preset. When charging starts, the charging time is recorded as 0, and the current temperature is collected. During the sampling process, a temperature T of the terminal and a corresponding sampling time t are collected sequentially at an interval of each sampling cycle, and the charging parameter is recorded as (t, T), so as to obtain multiple charging parameters during the charging process.

It should be noted that the number of charging parameters and the sampling cycle can be set according to an actual case.

S2: A temperature change trend of the charging apparatus is estimated based on the charging parameter.

In an embodiment, a structure of a terminal of the charging apparatus and another terminal of the charging apparatus paired with the terminal is shown in FIG. 2. A heating rate of a high-voltage terminal in the charging apparatus is I²R, where I is a charging current, and R is a resistor connected to the terminal. The connected resistor includes a connected resistor at a cable crimping position (that is, a crimping position A4 and a crimping position B6 of a cable 1) and a connected resistor at a reed docking part 5 (that is, a docking part between a jack 2 and a pin 3). During the entire charging process, a heating rate and a heat dissipation rate of the charging apparatus terminal are expressed by the following formula:

$$C m Δτ = {I}^{2} R - ( {∅}_{1} + {∅}_{2} + {∅}_{3} )$$

C is a heat capacity of the terminal, m is a mass of the terminal, Δτ is a temperature rise rate of the terminal, and ∅₁, ∅₂, and ∅₃ are a conductive heat dissipation rate, a convection heat dissipation rate, and a radiation heat dissipation rate respectively.

When charging starts, a difference between the temperature of the terminal and the ambient temperature is small. Therefore, the heat dissipation rate (∅₁+∅₂+∅₃) is less than the heating rate (I²R). It can be seen from the above formula that when the heat capacity C and the mass m are determined, when charging starts, the temperature rise rate Δτ reaches the highest value. As time goes by, the temperature of the terminal constantly rises, the heat dissipation rate gradually approaches the heating rate, and the temperature rise rate Δτ also constantly decreases. When the temperature of the terminal rises so that the heating rate and the heat dissipation rate are equal, the temperature rise rate is 0. Then, the temperature no longer rises and reaches a temperature equilibrium state.

It can be seen from the above analysis that in the time-temperature rise curve of the terminal during the charging process, an initial slope is a fixed value Z (Z>0), the slope constantly decreases with the increase of the charging time t, and at a time point T0, the slope Z is 0, and the temperature T of the terminal converges to a fixed value T0.

To obtain the temperature-time relationship of the charging apparatus during the charging process, the multiple charging parameters may be marked in a coordinate system with the time t on the horizontal axis and the temperature T on the vertical axis, and then connected to obtain a corresponding temperature-time relationship curve, to estimate the temperature change trend of the charging apparatus. The temperature change trend of the charging apparatus may also be estimated by establishing a relationship formula between the temperature and the time. Since it is difficult to deduce the relationship formula by analyzing the structure of the charging apparatus, in this embodiment, the obtained charging parameters are used to fit the curve, that is, the obtained charging parameters (t, T) are substituted into a preset fitting function to obtain the corresponding temperature-time relationship through the function construction, to obtain the time-temperature rise curve of the charging apparatus during the charging process, that is, the change relationship between the temperature and the time. The fitting function may be expressed by Taylor's formula, least squares fitting function formula, or the like. It can be understood that although the curve described by fitting is an approximation of the original curve, as long as there are sufficient known points on the curve, the changing pattern of the original curve can be described accurately through fitting.

It should be noted that because the estimation is for the current charging process of the charging apparatus, an estimation termination time may be set to an end time of the charging process of the charging apparatus. The charging time of the charging apparatus may be estimated based on the charging power, or determined by querying a model of a device that applies the charging apparatus. The method will not be described herein.

The following is a detailed description of the method of estimating the temperature change trend of the charging apparatus during the charging process through function construction.

According to an embodiment of the present disclosure, fitting a change relationship between a temperature and a time of the charging socket during a vehicle charging process based on a temperature sampling moment and a temperature sampling value of each temperature sampling point includes: multiple charging parameters of multiple sampling points and a fitting function are determined; the charging parameter of each sampling point is substituted into the fitting function to obtain various parameters in the fitting function; the obtained various parameters are substituted into the fitting function to obtain a temperature estimation model of the charging apparatus; and the temperature change trend of the charging apparatus is estimated based on the charging parameter and the temperature estimation model.

It should be noted that the number of sampling points should be greater than or equal to the number of the parameters in the fitting function to facilitate the solution of unknown parameters in the fitting function.

According to an embodiment of the present disclosure, the fitting function is expressed by the following formula:

$$T = {C}_{0} + {C}_{1} t + {C}_{2} {t}^{2} + {C}_{3} {t}^{3} + … + {C}_{n - 1} {t}^{n - 1} \qquad ( 1 )$$

T represents a temperature of the charging socket, t represents a charging time, C₀ to Cₙ₋₁ represent the various parameters of the fitting function, and n is a number of the temperature sampling points.

In an embodiment, for example, a formula (1) is used as the representative formula of the fitting function, and the number of parameters of the formula is n. When charging starts, the temperature of the terminal is collected by a temperature sensor arranged on the terminal of the charging apparatus, and is recorded as a charging parameter (t0, T0) in combination with time, and the temperature is collected and recorded once in each sampling cycle, ultimately forming n sampling points (t0, T0), (t1, T1), . . . , and (tn-1, Tn-1). Then, the charging parameters of these n sampling points are substituted into the one-variable Taylor's formula (1) to solve parameters C₀ to Cₙ₋₁, and the solved C₀ to Cₙ₋₁ are substituted into formula (1). Then, a temperature estimation model of the charging apparatus is constructed, the constructed formula (1) may be used to estimate a temperature at a next sampling time, and by analogy, the estimation of the temperature change trend of the charging apparatus during the charging process is completed.

It should be noted that the above formula (1) is a fitting function and can be replaced by other fitting functions to achieve the same effect. According to another embodiment of the present disclosure, the fitting function can be expressed by the following formula:

$$T ( t ) = {A}_{0} + {\sum }_{j = 1}^{n} {B}_{j} {e}^{- n {t}_{i}} + {\sum }_{j = 1}^{n} {C}_{j} arctan {t}_{i} \qquad ( 2 )$$

T represents a temperature of the charging socket, t represents a charging time, A₀, B₁ to Bₙ, and C₁ to Cₙ represent the various parameters of the fitting function, and n is a number of the temperature sampling points.

It can be understood that in addition to the above formula (1) and formula (2), the fitting function can also be expressed by other formulas according to the actual case, that is, the above two fitting functions can be replaced by other types of functions to achieve better fitting accuracy and estimation effect.

S3: When it is determined, based on the temperature change trend, that the highest estimated temperature is about to exceed a preset temperature threshold, the charging current is limited before the highest estimated temperature exceeds the preset temperature threshold. The preset temperature threshold of the charging apparatus can be pre-calibrated according to the actual application requirements of the charging apparatus. For example, the preset temperature threshold can be set to the maximum allowable temperature of the material of the charging port.

In an embodiment, after the fitting function is constructed, during the charging process, the temperature of the charging apparatus at all moments during the charging process can be calculated based on the fitting function, and the highest temperature during the charging process is used as the highest estimated temperature. The highest estimated temperature is then compared with the preset temperature threshold. For example, assuming that the temperature Tn of the charging socket at the estimation time tn is the highest estimated temperature during the entire charging process, the temperature Tn is compared with the preset temperature threshold. If Tn is greater than the preset temperature threshold, it means that the charging apparatus is subject to over-heating during the charging process. In this case, the charging current is adjusted before the time tn is reached. That is, the charging current is reduced in advance before the temperature exceeds the preset temperature limit to reduce the temperature of the charging apparatus during the charging process, to avoid over-heating. For example, the charging current may be adjusted at a current moment at which over-heating is estimated, or the charging current may be adjusted at a preset time period point before the tn time. The time interval between an adjustment time and tn can be set according to the actual case. If it is determined that the temperature Tn does not exceed the preset temperature threshold, it means that the charging apparatus is not subject to over-heating during the entire charging process, and there is no need to limit the charging current, that is, the charging power. The entire charging operation is completed with this charging current. Therefore, this method uses a mathematical model to estimate the temperature and estimate in advance whether the charging apparatus is subject to over-heating during the charging process. Compared with the existing temperature protection method, the method is safer and more reliable.

According to an embodiment of the present disclosure, the limiting the charging current before the estimated temperature exceeds the preset temperature threshold includes: the charging current is limited by gradually adjusting the charging current, so that the highest estimated temperature is within a preset temperature range. The preset temperature range can be set according to the actual case. For example, the preset temperature range may be about 70° C.˜125° C.

That is, when it is determined that the charging apparatus is subject to over-heating during the charging process, the charging current is first adjusted slightly, and then the updated temperature change trend of the charging apparatus is obtained, and the highest estimated temperature during the charging process is reobtained based on the updated temperature change trend, and it is further determined whether the highest estimated temperature reobtained is within the preset temperature range. If the highest estimated temperature still does not meet the requirement of the preset temperature range, the charging current is adjusted again, and this cycle continues until it is determined that the updated highest estimated temperature does not exceed the preset temperature range, and then the charging current is no longer adjusted. This current is used as the charging current to complete the entire charging process. As a result, the charging current can be adjusted faster and more effectively. This ensures a larger charging current as much as possible while the charging apparatus is not subject to over-heating.

According to an embodiment of the present disclosure, the limiting the charging current by gradually adjusting the charging current includes: an initial current during the charging process is determined; the initial current is reduced by a preset amount, to obtain a first current; and when controlling the charging apparatus to charge the device with the first current, a charging parameter within a first preset time period is obtained, the temperature change trend of the charging apparatus is estimated based on the charging parameter within the first preset time period, the updated highest estimated temperature is obtained, and if the updated highest estimated temperature exceeds an upper limit of the preset temperature range (e.g., the preset temperature threshold), the first current continues to be reduced by a preset amount, until the updated highest estimated temperature is less than the upper limit of the preset temperature range. The first preset time period and the preset amount can be set according to the actual case.

In an embodiment, it is assumed that the preset temperature range is [T′, T″], the preset amount is ΔI, and the initial current during the charging process is I. When it is estimated that there is a highest estimated temperature greater than the preset temperature threshold during the charging process, ΔI is subtracted from the initial current I to obtain a first current I1, charging continues with the first current I1, temperature sampling is performed again through the temperature sensor to obtain n charging parameters within a first preset time period, and n charging parameters are substituted into the above formula (1) or (2) to obtain a new temperature estimation model of the charging apparatus. Then, the temperature change trend of the charging apparatus is estimated again by obtaining the charging parameters and the temperature estimation model again, to obtain the updated highest estimated temperature T1, the temperature T1 is compared with the upper limit value T″ of the preset temperature range, if T1 is greater than T″, Il continues to be reduced by ΔI, and the above operations are repeated until the updated highest estimated temperature T1 is less than or equal to the upper limit T″.

When the updated highest estimated temperature does not exceed the upper limit of the preset temperature range, the highest estimated temperature is compared with the lower limit of the preset temperature range. According to an embodiment of the present disclosure, the limiting the charging current by gradually adjusting the charging current further includes: when controlling the charging apparatus to charge the device with the first current, a relationship between the updated highest estimated temperature and a lower limit of the preset temperature range is determined; and if the updated highest estimated temperature is less than the lower limit of the preset temperature range, a second current is determined based on the initial current and the first current, the charging apparatus is controlled to charge the device with the second current, a charging parameter within a second preset time period is obtained, the temperature change trend of the charging apparatus is estimated based on the charging parameter within the second preset time period, the updated highest estimated temperature (e.g., second updated highest estimated temperature) is obtained, and if the updated highest estimated temperature is still less than the lower limit of the preset temperature range, a value of the second current is assigned to the first current until the updated highest estimated temperature is greater than or equal to the lower limit of the preset temperature range, where the second current is greater than the first current and less than the initial current. The second preset time period can be set according to the actual application.

According to an embodiment of the present disclosure, the determining a second current according to the initial current and the first current includes: the initial current and the first current are added to obtain a sum, and the sum is halved to obtain the second current.

In an embodiment, the example of the preset temperature range [T′, T″], the initial current I during the charging process, and the first current Il is still used. The temperature T1 that is less than or equal to T″ is compared with the lower limit T′ of the preset temperature range, if T1 is less than T′, the second current I2 is calculated through the formula (I+I1)/2=I2, the current I2 is used as the charging current to perform the charging operation, charging parameters are obtained within a second preset time period, and a new temperature estimation model is obtained through the above method. According to the charging parameters and the temperature estimation model reobtained with I2 as the charging current, a new highest estimated temperature is obtained and recorded as a temperature T2. The temperature T2 is compared with the lower limit T′, if the temperature T2 is still less than T′, I1=I2, that is, a value of I2 is assigned to I1, the reassigned Il is substituted into the formula (I+I1)/2=I2 to obtain the new second current I2 again as the charging current for the charging operation, and the above operations are repeated to obtain the estimation model and the corresponding updated highest estimated temperature T2 again, and so on, until the highest estimated temperature T2 of the charging apparatus is greater than or equal to the lower limit T′.

Further, according to an embodiment of the present disclosure, the limiting the charging current by gradually adjusting the charging current further includes: when controlling the charging apparatus to charge the device with the second current, if the updated highest estimated temperature is greater than the upper limit of the preset temperature range, the value of the second current is assigned to the initial current until the updated highest estimated temperature is less than or equal to the upper limit of the preset temperature range.

That is, if the highest estimated temperature T2 obtained through estimation during charging with the second current I2 is greater than the upper limit T″, a value of I2 is assigned to the initial current I, that is, I=I2, and the reassigned I is substituted into the formula (I+I1)/2=I2, to obtain the new second current I2 again, and then the above operations are repeated to obtain a new highest estimated temperature T2 until T2 is less than or equal to the upper limit T″.

In this embodiment, after estimating the temperature rise of the charging apparatus through the above fitting function, a preset amount is first used to adjust the charging current slightly, the temperature change trend of the charging apparatus at this time is detected and a new estimated highest temperature is obtained, and then the relationship between the estimated highest temperature reobtained and the preset temperature range is determined. When the estimated highest temperature reobtained is greater than the preset temperature range, the current is further adjusted by the preset amount. If the estimated highest temperature reobtained is less than the preset temperature range, the charging current is re-adjusted to the intermediate value before and after the change, and the estimated highest temperature is reobtained. In this way, the current average is obtained through continuous cycles until the updated estimated highest temperature changes within the allowable range (that is, the preset temperature range), and the adjustment of the charging current is stopped and the charging current is considered to reach the optimal value. This method enables the charging process to automatically reach the maximum allowable charging current while the charging apparatus is not subject to over-heating, avoiding previous difficulty in setting the temperature threshold.

It should be noted that in addition to the above formula (I+I1)/2=I2, the method for obtaining the second current can also be set according to the actual case.

According to an embodiment of the present disclosure, the limiting the charging current by gradually adjusting the charging current further includes: when controlling the charging apparatus to charge the device with the second current, if the updated highest estimated temperature is within the preset temperature range, the current charging current (i.e., the second current) is maintained.

That is, if the charging current is the second current I2, the current temperature T2 satisfies: T′≤TI≤T″, then the adjustment of the charging current is stopped, and the charging operation is continued with the second current I2 as the charging current until the charging is completed.

According to an embodiment of the present disclosure, the limiting the charging current by gradually adjusting the charging current further includes: when controlling the charging apparatus to charge the device with the first current, if the updated highest estimated temperature is within the preset temperature range, the current charging current (i.e., the first current) is maintained.

That is, if the highest estimated temperature T1 estimated during the charging process with the first current I1 satisfies: T′≤T1≤T″, the current adjustment is stopped and charging is continued with the first current I1 until the charging is completed.

It is understandable that during the charging process, the adjustment of the charging current is also controlled by the battery, the motor, electronic control and other components in the device. Therefore, when controlling the charging current, the above method of over-heating protection for a charging apparatus needs to be combined with limitations of other products of the device in comprehensive conditions, to meet the temperature limit requirements of the products.

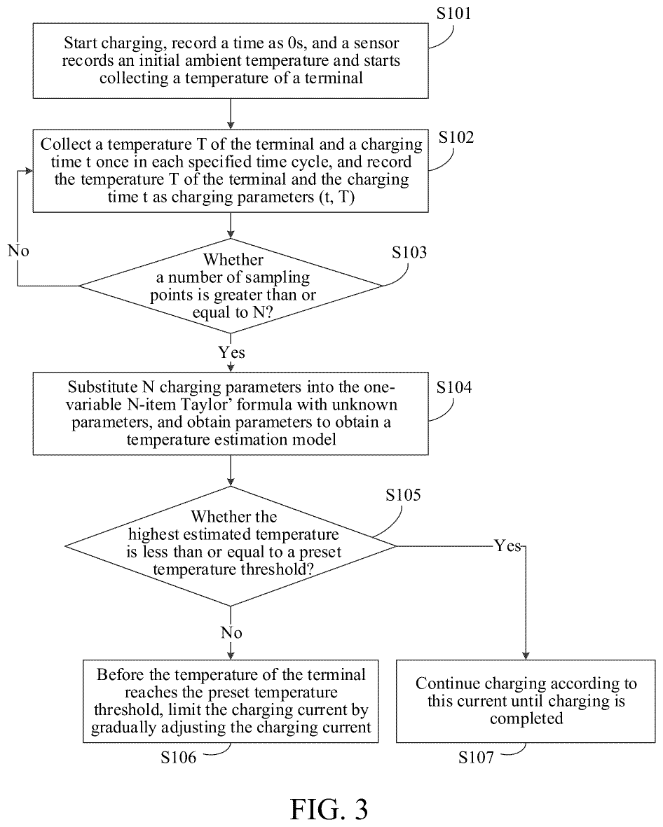

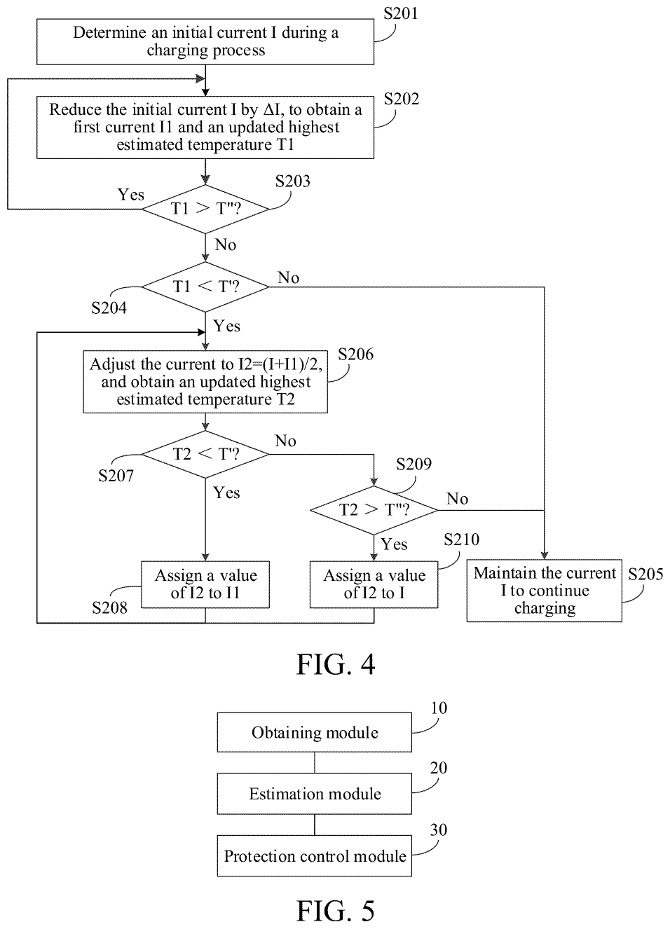

As an embodiment of the present disclosure, a temperature sensor is installed at the terminal of the charging apparatus, and collects the real-time temperature of the terminal as the temperature of the charging apparatus. As shown in FIG. 3 and FIG. 4, the method of over-heating protection for a charging apparatus includes the following steps. A preset number of sample points is N, the formula of the fitting function is the one-variable N-term Taylor's formula with unknown parameters, that is, the number of parameters in the formula is N, and the preset temperature threshold of the charging apparatus is the maximum allowable temperature of the material of the charging port.

S101: Charging is started, a time is recorded as 0s, and a sensor records an initial ambient temperature and starts collecting a temperature of a terminal.

S102: A temperature T of the terminal and a charging time t are collected once in each specified sampling time, and are recorded as charging parameters (t, T).

S103: It is determined whether a number of sampling points is greater than or equal to N. If yes, step S104 is performed. If not, step S102 is performed.

S104: N charging parameters are substituted into the one-variable N-item Taylor' formula with unknown parameters, and parameters are obtained to obtain a temperature estimation model of the charging apparatus.

S105: It is determined whether the highest estimated temperature determined by estimating the temperature change trend based on the charging parameters and the temperature estimation model is greater than a preset temperature threshold. If yes, step S106 is performed. If not, step S107 is performed.

S106: Before the temperature of the terminal reaches the preset temperature threshold, the charging current is limited by gradually adjusting the charging current.

S107: Charging is continued according to this current until charging is completed.

The operation steps of the above step S106 are shown in FIG. 4, including the following steps. The preset temperature range is [T′, T″], and the preset amount is ΔI.

S201: An initial current I during a charging process is determined.

S202: The initial current I is reduced by ΔI, to obtain a first current Il and an updated highest estimated temperature T1.

S203: It is determined whether T1 is greater than T″. If yes, step S202 is performed. If not, step S204 is performed.

S204: It is determined whether T1 is less than T′. If yes, step S206 is performed. If not, step S205 is performed.

S205: The current charging current is maintained until charging is completed.

S206: The charging current is adjusted to a second current I2=(I+I1)/2, and an updated highest estimated temperature T2 is obtained.

S207: It is determined whether T2 is less than T′. If yes, step S208 is performed. If not, step S209 is performed.

S208: A value of I2 is assigned to I1, and step S206 is performed.

S209: It is determined whether T2 is greater than T″. If yes, step S210 is performed. If not, step S205 is performed.

S210: A value of I2 is assigned to I, and step S206 is performed.

In conclusion, according to the method of over-heating protection for a charging apparatus according to the embodiments of the present disclosure, first, a charging parameter of a charging apparatus during a charging process is obtained, where the charging parameter includes a time and a temperature, and the time corresponds to the temperature, then a temperature change trend of the charging apparatus is estimated based on the charging parameter, and finally, when it is determined based on the temperature change trend that the highest estimated temperature is about to exceed a preset temperature threshold, the charging current is limited before the highest estimated temperature exceeds the preset temperature threshold. Therefore, in this method, a temperature change trend of a charging apparatus is estimated based on a charging parameter, and it can be estimated in advance whether the charging apparatus is subject to over-heating during a charging process, so that the charging current can be adjusted faster and more effectively, and safety and reliability are improved.

Corresponding to the foregoing embodiments, the present disclosure further proposes an apparatus of over-heating protection for a charging apparatus.

As shown in FIG. 5, the apparatus of over-heating protection for a charging apparatus according to this embodiment of the present disclosure may include: an obtaining module 10, an estimation module 20 and a protection control module 30.

The obtaining module 10 is configured to obtain/measure a charging parameter of a charging apparatus during a charging process, where the charging parameter includes a time and a temperature, and the time corresponds to the temperature. The estimation module 20 is configured to estimate a temperature change trend of the charging apparatus based on the charging parameter. The protection control module 30 is configured to: when determining based on the temperature change trend that the highest estimated temperature is about to exceed a preset temperature threshold, limit the charging current before the highest estimated temperature exceeds the preset temperature threshold.

According to an embodiment of the present disclosure, when estimating the temperature change trend of the charging apparatus according to the charging parameter, the estimation module 20 is configured to: determine charging parameters of multiple sampling points and a fitting function; substitute the charging parameter of each sampling point into the fitting function to obtain various parameters in the fitting function; substitute the obtained various parameters into the fitting function to obtain a temperature estimation model of the charging apparatus; and estimate the temperature change trend of the charging apparatus based on the charging parameter and the temperature estimation model.

According to an embodiment of the present disclosure, the fitting function in the estimation module 20 is expressed by the following formula:

$$T = {C}_{0} + {C}_{1} t + {C}_{2} {t}^{2} + {C}_{3} {t}^{3} + … + {C}_{n - 1} {t}^{n - 1}$$

where T represents a temperature of the charging apparatus, t represents a charging time, C₀ to Cₙ₋₁ represent the various parameters of the fitting function, and n is a number of the temperature sampling points.

According to another embodiment of the present disclosure, the fitting function in the estimation module 20 is expressed by the following formula:

$$T ( t ) = {A}_{0} + {\sum }_{j = 1}^{n} {B}_{j} {e}^{- n {t}_{i}} + {\sum }_{j = 1}^{n} {C}_{j} arctan {t}_{i}$$

where T represents a temperature of the charging apparatus, t represents a charging time, A₀, B₁ to Bₙ, and C₁ to Cₙ represent the various parameters of the fitting function, and n is a number of the temperature sampling points.

According to an embodiment of the present disclosure, when limiting the charging current before the highest estimated temperature exceeds the preset temperature threshold, the protection control module 30 is configured to: limit the charging current by gradually adjusting the charging current, and the highest estimated temperature is within a preset temperature range.

According to an embodiment of the present disclosure, when limiting the charging current by gradually adjusting the charging current, the protection control module 30 is configured to: determine an initial current during the charging process; reduce the initial current by a preset amount, to obtain a first current; and when controlling the charging apparatus to charge the device with the first current, obtain a charging parameter within a first preset time period, estimate the temperature change trend of the charging apparatus based on the charging parameter within the first preset time period, obtain the updated highest estimated temperature, and if the updated highest estimated temperature exceeds an upper limit of the preset temperature range, continue to reduce the first current by a preset amount, until the updated highest estimated temperature does not exceed the upper limit of the preset temperature range.

According to an embodiment of the present disclosure, when limiting the charging current by gradually adjusting the charging current, the protection control module 30 is configured to: when controlling the charging apparatus to charge the device with the first current, if the updated highest estimated temperature does not exceed the upper limit of the preset temperature range, determine a relationship between the updated highest estimated temperature and a lower limit of the preset temperature range; and if the updated highest estimated temperature is less than the lower limit of the preset temperature range, determine a second current based on the initial current and the first current, control the charging apparatus to charge the device with the second current, obtain a charging parameter within a second preset time period, estimate the temperature change trend of the charging apparatus based on the charging parameter within the second preset time period, obtain the updated highest estimated temperature, and if the updated highest estimated temperature is still less than the lower limit of the preset temperature range, assign a value of the second current to the first current until the updated highest estimated temperature is greater than or equal to the lower limit of the preset temperature range, where the second current is greater than the first current and less than the initial current.

According to an embodiment of the present disclosure, when limiting the charging current by gradually adjusting the charging current, the protection control module 30 is configured to: when controlling the charging apparatus to charge the device with the second current, if the updated highest estimated temperature is greater than the upper limit of the preset temperature range, assign the value of the second current to the initial current until the updated highest estimated temperature is less than or equal to the upper limit of the preset temperature range.

According to an embodiment of the present disclosure, when determining the second current according to the initial current and the first current, the protection control module 30 is configured to: add the initial current and the first current to obtain a sum, and halve the sum to obtain the second current.

According to an embodiment of the present disclosure, when limiting the charging current by gradually adjusting the charging current, the protection control module 30 is configured to: when controlling the charging apparatus to charge the device with the second current, if the updated highest estimated temperature is within the preset temperature range, maintain the current charging current (i.e., the second current).

According to an embodiment of the present disclosure, when limiting the charging current by gradually adjusting the charging current, the protection control module 30 is configured to: when controlling the charging apparatus to charge the device with the first current, if the updated highest estimated temperature is within the preset temperature range, maintain the current charging current (i.e., the first current).

It should be noted that for the details not disclosed in the apparatus of over-heating protection for a charging apparatus in the embodiments of the present disclosure, refer to the details disclosed in the method of over-heating protection for a charging apparatus in the above embodiments of the present disclosure, which will not be detailed here.

In conclusion, according to the apparatus of over-heating protection for a charging apparatus according to the embodiments of the present disclosure, the obtaining module obtains a charging parameter of a charging apparatus during a charging process, the estimation module estimates a temperature change trend of the charging apparatus based on the charging parameter, and when it is determined based on the temperature change trend that the highest estimated temperature is about to exceed a preset temperature threshold, the protection control module limits the charging current before the highest estimated temperature exceeds the preset temperature threshold. Therefore, in this apparatus, a temperature change trend of a charging apparatus is estimated based on a charging parameter, and it can be estimated in advance whether the charging apparatus is subject to over-heating during a charging process, so that the charging current can be adjusted faster and more effectively, and safety and reliability are improved.

Corresponding to the foregoing embodiments, the present disclosure further proposes an electric vehicle.

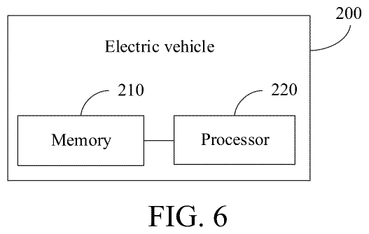

As shown in FIG. 6, the electric vehicle 200 according to the embodiment of the present disclosure may include: a memory 210, a processor 220, and an over-heating protection program for a charging apparatus stored in the memory 210 and executable by the processor 220, when the over-heating protection program is executed by the processor 220, the foregoing method of over-heating protection for a charging apparatus is implemented.

According to the electric vehicle according to the embodiments of the present disclosure, based on the foregoing method of over-heating protection for a charging apparatus, a temperature change trend of a charging apparatus is estimated based on a charging parameter, and it can be estimated in advance whether the charging apparatus is subject to over-heating during a charging process, so that the charging current can be adjusted faster and more effectively, and safety and reliability are improved.

Corresponding to the foregoing embodiments, the present disclosure further proposes a non-transitory computer-readable storage medium.

The non-transitory computer-readable storage medium according to this embodiment of the present disclosure stores an over-heating protection program for a charging apparatus, when the over-heating protection program for a charging apparatus is executed by a processor, the foregoing method of over-heating protection for a charging apparatus is implemented.

According to the non-transitory computer-readable storage medium of the embodiments of the present disclosure, based on the foregoing method of over-heating protection for a charging apparatus, a temperature change trend of a charging apparatus is estimated based on a charging parameter, and it can be estimated in advance whether the charging apparatus is subject to over-heating during a charging process, so that the charging current can be adjusted faster and more effectively, and safety and reliability are improved.

It should be noted that the logic and/or steps shown in the flowcharts or described in any other manner herein, for example, a sequenced list that may be considered as executable instructions used for implementing logical functions, may be implemented in any computer-readable medium to be used by an instruction execution system, apparatus, or device (for example, a computer-based system, a system including a processor, or another system that can obtain an instruction from the instruction execution system, apparatus, or device and execute the instruction) or to be used by combining such instruction execution systems, apparatuses, or devices. In the context of this specification, a “computer-readable medium” may be any apparatus that can include, store, communicate, propagate, or transmit the program for use by the instruction execution system, apparatus, or device or in combination with the instruction execution system, apparatus, or device. More examples (non-exhaustive list) of the computer-readable medium include the following: an electrical connection (electronic apparatus) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the computer-readable medium can even be paper or other suitable media on which the program can be printed, because the program can be obtained electronically by, for example, optically scanning paper or other media, then editing, interpreting, or processing in other suitable ways if necessary, and then storing it in a computer memory.

It should be understood that, parts of the present disclosure can be implemented by using hardware, software, firmware, or a combination thereof. In the foregoing implementations, multiple steps or methods may be implemented by using software or firmware that are stored in a memory and are executed by a proper instruction execution system. For example, if hardware is used for implementation, same as in another implementation, implementation may be performed by any one of the following technologies well known in the art or a combination thereof: a discrete logic circuit including a logic gate circuit for implementing a logic function of a data signal, a dedicated integrated circuit including a proper combined logic gate circuit, a programmable gate array (PGA), a field programmable gate array (FPGA), and the like.

In the description of this specification, the description of the reference terms “an embodiment”, “some embodiments”, “an example”, “a specific example”, “some examples,” and the like means that features, structures, materials or characteristics described in combination with the embodiment(s) or example(s) are included in at least one embodiment or example of the present disclosure. In this specification, descriptions of the foregoing terms do not necessarily refer to the same embodiment or example. In addition, the described features, structures, materials, or characteristics may be combined in a proper manner in any one or more of the embodiments or examples.

In addition, terms “first” and “second” are used merely for the purpose of description, and shall not be construed as indicating or implying relative importance or implying a quantity of indicated technical features. Therefore, a feature restricted by “first” or “second” may explicitly indicate or implicitly include at least one of such features. In the descriptions of the present disclosure, unless explicitly specified, “multiple” means at least two, for example, two or three.

Although the embodiments of the present disclosure have been shown and described above, it can be understood that, the foregoing embodiments are examples and should not be understood as limitation to the present disclosure. A person of ordinary skill in the art can make changes, modifications, replacements, or variations to the foregoing embodiments within the scope of the present disclosure.

What is claimed is:

1. A method of over-heating protection for a charging apparatus, comprising:
measuring a charging parameter of the charging apparatus during a charging process, wherein the charging parameter comprises a temperature and a time corresponding to the temperature;
estimating a temperature change trend of the charging apparatus based on the charging parameter; and
when determining, based on the temperature change trend, that a highest estimated temperature exceeds an upper limit of a preset temperature range, limiting a charging current for the charging apparatus before an estimated temperature exceeds the upper limit of the preset temperature range.

2. The method according to claim 1, wherein the estimating the temperature change trend of the charging apparatus based on the charging parameter comprises:
determining a fitting function and a plurality of charging parameters of a plurality of sampling points;
substituting the charging parameters of the sampling points into the fitting function to obtain various parameters in the fitting function;
substituting the various parameters into the fitting function to obtain a temperature estimation model of the charging apparatus; and
estimating the temperature change trend of the charging apparatus based on the charging parameters and the temperature estimation model.

3. The method according to claim 2, wherein the fitting function is expressed by:
$$T = {C}_{0} + {C}_{1} t + {C}_{2} {t}^{2} + {C}_{3} {t}^{3} + … + {C}_{n - 1} {t}^{n - 1}$$
wherein T represents a temperature of the charging apparatus, t represents a charging time, C₀ to Cₙ₋₁ represent the various parameters of the fitting function, and n is a number of temperature sampling points.

4. The method according to claim 2, wherein the fitting function is expressed by:
$$T ( t ) = {A}_{0} + {\sum }_{j = 1}^{n} {B}_{j} {e}^{- n {t}_{i}} + {\sum }_{j = 1}^{n} {C}_{j} arctan {t}_{i}$$
wherein T represents a temperature of the charging apparatus, t represents a charging time, A₀, B₁ to Bₙ, and C₁ to Cₙ represent the various parameters of the fitting function, and n is a number of temperature sampling points.

5. The method according to claim 1, wherein the limiting the charging current for the charging apparatus before the estimated temperature exceeds the upper limit of the preset temperature range comprises:
limiting the charging current by gradually adjusting the charging current such that the highest estimated temperature is reduced to within the preset temperature range.

6. The method according to claim 5, wherein the limiting the charging current by gradually adjusting the charging current comprises:
determining an initial current during the charging process;
reducing the initial current by an amount to obtain a first current; and
controlling the charging apparatus to charge a device with the first current, obtaining a first charging parameter within a first time period, estimating the temperature change trend of the charging apparatus based on the first charging parameter within the first time period, and updating the highest estimated temperature, if the updated highest estimated temperature exceeds the upper limit of the preset temperature range, reducing the first current by the amount, until the updated highest estimated temperature does not exceed the upper limit of the preset temperature range.

7. The method according to claim 6, wherein the limiting the charging current by gradually adjusting the charging current further comprises:
controlling the charging apparatus to charge the device with the first current;
if the updated highest estimated temperature does not exceed the upper limit of the preset temperature range, determining a relationship between the updated highest estimated temperature and a lower limit of the preset temperature range; and
if the updated highest estimated temperature is less than the lower limit of the preset temperature range, determining a second current based on the initial current and the first current, controlling the charging apparatus to charge the device with the second current, obtaining a second charging parameter within a second time period, estimating the temperature change trend of the charging apparatus based on the second charging parameter within the second time period, updating the updated highest estimated temperature to obtain a second updated highest estimated temperature, if the second updated highest estimated temperature is less than the lower limit of the preset temperature range, assigning a value of the second current to the first current, until the second updated highest estimated temperature is greater than or equal to the lower limit of the preset temperature range, wherein the second current is greater than the first current and less than the initial current.

8. The method according to claim 7, wherein the limiting the charging current by gradually adjusting the charging current further comprises:
if the second updated highest estimated temperature is greater than the upper limit of the preset temperature range, assigning the value of the second current to the initial current until a second subsequent updated highest estimated temperature is less than or equal to the upper limit of the preset temperature range.

9. The method according to claim 7, wherein the determining the second current based on the initial current and the first current comprises:
adding the initial current and the first current to obtain a sum, and halving the sum to obtain the second current.

10. The method according to claim 7, wherein the limiting the charging current by gradually adjusting the charging current further comprises:
if the second updated highest estimated temperature is within the preset temperature range, maintaining the second current.

11. The method according to claim 6, wherein the limiting the charging current by gradually adjusting the charging current further comprises:
if the updated highest estimated temperature is within the preset temperature range, maintaining the first current.

12. An electric vehicle, comprising: a memory, a processor, and a program stored in the memory, wherein the processor is configured to execute the program and performs operations comprising:
measuring a charging parameter of a charging apparatus during a charging process, wherein the charging parameter comprises a temperature and a time corresponding to the temperature;
estimating a temperature change trend of the charging apparatus based on the charging parameter; and
when determining, based on the temperature change trend, that a highest estimated temperature exceeds an upper limit of a preset temperature range, limiting a charging current for the charging apparatus before an estimated temperature exceeds the upper limit of the preset temperature range.

13. The electric vehicle according to claim 12, wherein the estimating the temperature change trend of the charging apparatus based on the charging parameter comprises:
determining a fitting function and a plurality of charging parameters of a plurality of sampling points;
substituting the charging parameters of the sampling points into the fitting function to obtain various parameters in the fitting function;
substituting the various parameters into the fitting function to obtain a temperature estimation model of the charging apparatus; and
estimating the temperature change trend of the charging apparatus based on the charging parameters and the temperature estimation model.

14. The electric vehicle according to claim 13, wherein the fitting function is expressed by:
$$T = {C}_{0} + {C}_{1} t + {C}_{2} {t}^{2} + {C}_{3} {t}^{3} + … + {C}_{n - 1} {t}^{n - 1}$$
wherein T represents a temperature of the charging apparatus, t represents a charging time, C₀ to Cₙ₋₁ represent the various parameters of the fitting function, and n is a number of temperature sampling points.

15. The electric vehicle according to claim 13, wherein the fitting function is expressed by:
$$T ( t ) = {A}_{0} + {\sum }_{j = 1}^{n} {B}_{j} {e}^{- n {t}_{i}} + {\sum }_{j = 1}^{n} {C}_{j} arctan {t}_{i}$$
wherein T represents a temperature of the charging apparatus, t represents a charging time, A₀, B₁ to Bₙ, and C₁ to Cₙ represent the various parameters of the fitting function, and n is a number of temperature sampling points.

16. The electric vehicle according to claim 12, wherein the limiting the charging current for the charging apparatus before the estimated temperature exceeds the upper limit of the preset temperature range comprises:
limiting the charging current by gradually adjusting the charging current such that the highest estimated temperature is reduced to within the preset temperature range.

17. The electric vehicle according to claim 16, wherein the limiting the charging current by gradually adjusting the charging current comprises:
determining an initial current during the charging process;
reducing the initial current by an amount to obtain a first current; and
controlling the charging apparatus to charge a device with the first current, obtaining a first charging parameter within a first time period, estimating the temperature change trend of the charging apparatus based on the first charging parameter within the first time period, and updating the highest estimated temperature, if the updated highest estimated temperature exceeds the upper limit of the preset temperature range, reducing the first current by the amount, until the updated highest estimated temperature does not exceed the upper limit of the preset temperature range.

18. The electric vehicle according to claim 17, wherein the limiting the charging current by gradually adjusting the charging current further comprises:
controlling the charging apparatus to charge the device with the first current;
if the updated highest estimated temperature does not exceed the upper limit of the preset temperature range, determining a relationship between the updated highest estimated temperature and a lower limit of the preset temperature range; and
if the updated highest estimated temperature is less than the lower limit of the preset temperature range, determining a second current based on the initial current and the first current, controlling the charging apparatus to charge the device with the second current, obtaining a second charging parameter within a second time period, estimating the temperature change trend of the charging apparatus based on the second charging parameter within the second time period, updating the updated highest estimated temperature to obtain a second updated highest estimated temperature, if the second updated highest estimated temperature is less than the lower limit of the preset temperature range, assigning a value of the second current to the first current, until the second updated highest estimated temperature is greater than or equal to the lower limit of the preset temperature range, wherein the second current is greater than the first current and less than the initial current.

19. The electric vehicle according to claim 18, wherein the limiting the charging current by gradually adjusting the charging current further comprises:
if the second updated highest estimated temperature is greater than the upper limit of the preset temperature range, assigning the value of the second current to the initial current until a second subsequent updated highest estimated temperature is less than or equal to the upper limit of the preset temperature range.

20. A non-transitory computer-readable storage medium storing a program, which when executed by a processor, causes the processor to perform operations comprising:
measuring a charging parameter of a charging apparatus during a charging process, wherein the charging parameter comprises a temperature and a time corresponding to the temperature;
estimating a temperature change trend of the charging apparatus based on the charging parameter; and
when determining, based on the temperature change trend, that a highest estimated temperature exceeds an upper limit of a preset temperature range, limiting a charging current for the charging apparatus before an estimated temperature exceeds the upper limit of the preset temperature range.
